(19) United States
(12) Patent Application Publication
(10) Pub. No.: US 2017/0026475 A1
(43) Pub. Date: Jan. 26, 2017

(54) METHODS AND SYSTEMS FOR CONNECTING TO A SOCIAL NETWORK SERVICE

(71) Applicant: Noodoe Corporation, Taipei City (TW)

(72) Inventor: John C. Wang, Taipei City (TW)

(21) Appl. No.: 15/202,641

(22) Filed: Jul. 6, 2016

(30) Foreign Application Priority Data
Jul. 21, 2015 (TW) 104123485

(51) Int. Cl. H04L 29/08; H04W 4/00

(52) U.S. Cl. CPC H04L 67/16; H04W 4/008; H04L 67/141; H04L 67/28

(57) ABSTRACT

Methods and systems for connecting to a social network service are provided. First, at least one specific electronic device generates specific data, and transmits the specific data via a first network. Then, an intermediate electronic device receives the specific data from the specific electronic device via the first network, and in response to the specific data, connects to a social network service via a second network.

### BACKGROUND OF THE INVENTION

Field of the Invention

The disclosure relates generally to methods and systems for connecting to a social network service, and, more particularly to methods and systems that can receive data from an electronic device, and, in response to the received data, automatically connect to a social network service in response to the received data.

Description of the Related Art

Recently, portable devices, such as smart phones or notebooks, have become more and more technically advanced and multifunctional. For example, a portable device may have network connecting capabilities. Users can use their portable devices to connect to networks anytime and anywhere. Due to increased convenience and expanded functionalities of the devices, these devices have become necessities of life.

Furthermore, social network services have become a very important communication medium for users. Users can post their undertakings on the social network and share information with friends. For example, when a user dines at a restaurant, the user can use a portable device to check in at that restaurant by using a check-in function of a social network service, thus posting their newest undertaking on the social network. Additionally, the user can also upload a photo corresponding to the restaurant or a dish to the social network, and accordingly post a comment. Friends of the user can obtain the information of the restaurant according to the photo corresponding to the restaurant or the dish, or the comments shared by the user on the social network.

Generally users must manually use their portable devices to connect to a social network service. Since different users may have different skill levels with regards to operating their portable device and the social network service, for some users, it may be difficult to complete the whole process of photographing a restaurant or a dish, making comments, and uploading photos or comments. Furthermore, since users post data of restaurants or dishes on social network independently and in unique ways. Consequently, the format and the manner for sharing and commenting with regards to the same restaurant by different users may be different. Since the format and the manner for sharing and commenting may be different, the data is very difficult to manage.

### BRIEF SUMMARY OF THE INVENTION

Methods and systems for connecting to a social network service are provided, wherein an electronic device can automatically connect to a social network service in response to data received from another electronic device.

In an embodiment of a method for connecting to a social network service, specific data is generated by at least one specific electronic device, and the specific data is transmitted via a first network by the at least one specific electronic device. Then, the specific data is received by an intermediate electronic device from the specific electronic device via the first network. In response to the specific data, the intermediate electronic device connects to a social network service via a second network.

An embodiment of a system for connecting to a social network service comprises at least one specific electronic device and an intermediate electronic device. The at least one specific electronic device generates specific data, and transmits the specific data via a first network. The intermediate electronic device receives the specific data from the specific electronic device via the first network, and in response to the specific data, connects to a social network service via a second network.

In some embodiments, the intermediate electronic device transmits the specific data to a server via the second network. In response to the specific data, the server connects to the social network service via a third network.

In some embodiments, the server gathers statistics for the specific data received from different intermediate electronic devices, and the server posts information on a social network corresponding to the social network service according to a statistical results corresponding to the statistics.

In some embodiments, the intermediate electronic device posts information on a social network corresponding to the social network service according to the specific data.

In some embodiments, the specific electronic device comprises at least one sensor for detecting a motion or posture corresponding to the specific electronic device. The specific electronic device generates the specific data according to the motion or posture corresponding to the specific electronic device.

In some embodiments, the specific electronic device comprises at least one physical key. When the physical key is pressed, the specific electronic device generates the specific data.

In some embodiments, the specific electronic device determines whether a specific condition is met or not. When the specific condition is met, the specific electronic device generates the specific data.

In an embodiment of a method for connecting to a social network service, a motion or posture corresponding to an electronic device is detected by at least one sensor of the electronic device. When the motion or posture corresponding to the electronic device conforms or substantially conforms to a predefined motion or a predefined posture, the electronic device automatically connects to a social network service.

In an embodiment of a system for connecting to a social network service comprises a network connecting unit, at least one sensor, and a controller. The at least one sensor detects a motion or posture corresponding to an electronic device. The controller determines whether the motion or posture corresponding to the electronic device conforms or substantially conforms to a predefined motion or a predefined posture. When the motion or posture corresponding to the electronic device conforms or substantially conforms to a predefined motion or a predefined posture, the controller automatically connects to a social network service via a network using the network connecting unit.

Methods for connecting to a social network service may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for connecting to a social network service of the invention;

FIG. 2 is a schematic diagram illustrating an embodiment of a specific electronic device of the invention;

FIG. 3 is a schematic diagram illustrating another embodiment of a specific electronic device of the invention;

FIG. 4 is a schematic diagram illustrating another embodiment of a specific electronic device of the invention;

FIG. 5 is a flowchart of an embodiment of a method for connecting to a social network service of the invention;

FIG. 6 is a schematic diagram illustrating another embodiment of a system for connecting to a social network service of the invention;

FIG. 7 is a flowchart of another embodiment of a method for connecting to a social network service of the invention;

FIG. 8 is a flowchart of an embodiment of a method for generating specific data of the invention;

FIG. 9 is a flowchart of another embodiment of a method for generating specific data of the invention;

FIG. 10 is a flowchart of another embodiment of a method for generating specific data of the invention;

FIG. 11 is a schematic diagram illustrating another embodiment of a system for connecting to a social network service of the invention; and

FIG. 12 is a flowchart of another embodiment of a method for connecting to a social network service of the invention.

### DETAILED DESCRIPTION OF THE INVENTION

Methods and system for connecting to a social network service are provided.

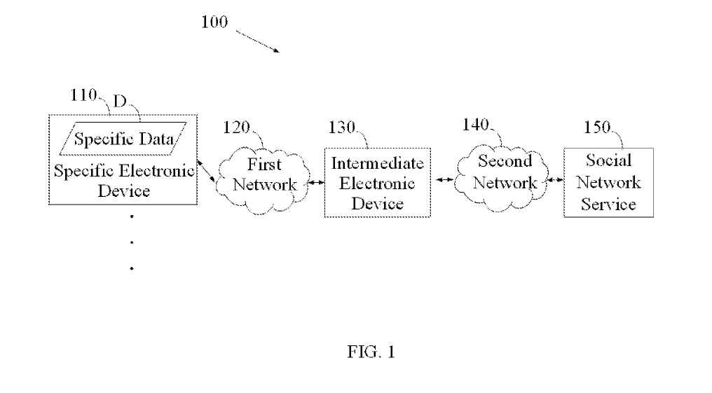

FIG. 1 is a schematic diagram illustrating an embodiment of a system for connecting to a social network service of the invention. The system for connecting to a social network service 100 comprises at least one specific electronic device 110 and an intermediate electronic device 130. The specific electronic device 110 and the intermediate electronic device 130 may be any electronic device having network connecting capabilities. The specific electronic device 110 can generate specific data D, and transmits the specific data D via a first network 120, such as a wired or a wireless network such as a Wi-Fi or a Bluetooth network. The intermediate electronic device 130 can receive the specific data D, which is transmitted from the different specific electronic devices 110. The intermediate electronic device 130 can connect to a social network service 150 via a second network 140, such as a wired or a wireless network. It is noted that, in some embodiments, the social network service 150 may be a service provided by at least one specific server (not shown in FIG. 1). For example, the social network service may be Facebook®. It is noted that, the above social network service is only an example of the present application, and the present invention is not limited thereto.

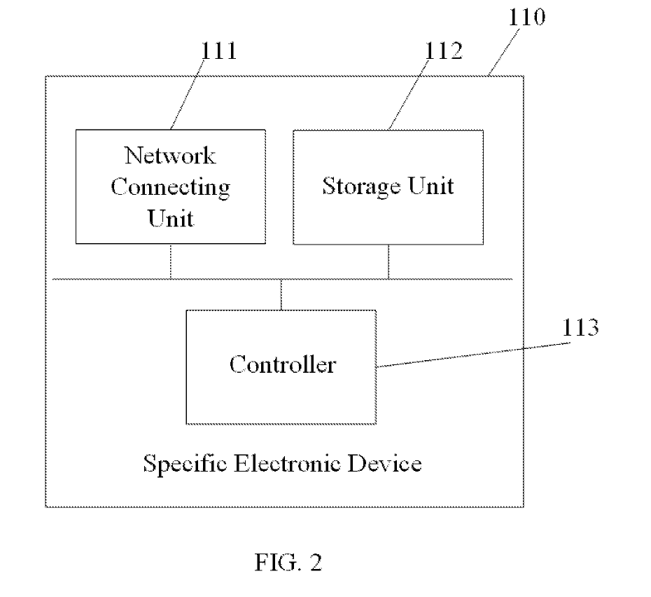

FIG. 2 is a schematic diagram illustrating an embodiment of a specific electronic device of the invention. As shown in FIG. 2, the specific electronic device 110 comprises a network connecting unit 111, a storage unit 112, and a controller 113. The network connecting unit 111 can transmit data and/or connect to other electronic devices having network connecting capabilities via a network, such as a wired or a wireless network such as Wi-Fi or Bluetooth network. It is understood that, in some embodiments, the network connecting unit 111 may be a network connecting unit implemented with a low-power consumption technology, such as Bluetooth Smart technology. The network connecting unit 111 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected to other electronic devices. The storage unit 112 can store related data, such as identification data corresponding to the specific electronic device 110. The controller 113 can control related operations of hardware and software in the specific electronic device 110.

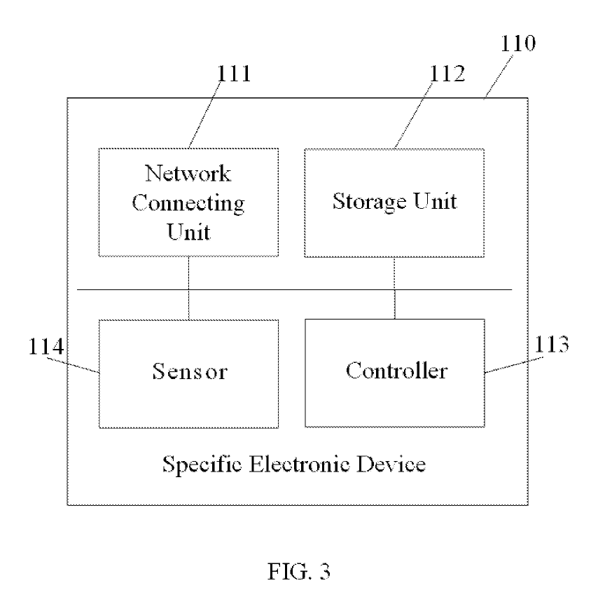

FIG. 3 is a schematic diagram illustrating another embodiment of a specific electronic device of the invention. As shown in FIG. 3, the specific electronic device 110 comprises a network connecting unit 141, a storage unit 112, at least one sensor 114, and a controller 113. The network connecting unit 111 can transmit data and/or connect to other electronic devices having network connecting capabilities via a network, such as a wired or wireless network such as Wi-Fi or Bluetooth network. Similarly, in some embodiments, the network connecting unit 111 may be a network connecting unit implemented with a low-power consumption technology, such as Bluetooth Smart technology. The network connecting unit 111 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected by other electronic devices. The storage unit 112 can store related data, such as identification data corresponding to the specific electronic device 110. It is understood that, in some embodiments, the sensor 114 can detect a posture and/or motion corresponding to the specific electronic device 110. For example, the sensor 114 may be an accelerometer for generating information of velocity and displacement when the device moves. In another example, the sensor 114 may be a Gyro sensor for generating information of angular acceleration when the device moves. In another example, the sensor 114 may be an e-compass for detecting an angle of the device in regard to a geographical direction, such as the direction of the North Pole or the South Pole. It is noted that, the above sensors are only examples of the present application, and the present invention is not limited thereto. Any sensor that can detect the posture and/or motion of an electronic device can be applied in the present invention. As described, the sensor 114 can detect the posture of the specific electronic device 110. It is understood that, in some embodiments, the posture can be the angular information of the specific electronic device 110 in regard to at least one reference point. In some embodiments, the posture of the specific electronic device 110 can be represented by an angle corresponding to an axis which is vertical to at least one plane of the specific electronic device 110 in regard to a specific direction, such as the gravity direction or the geographical direction. Additionally, in some embodiments, the sensor 114 can detect an environmental factor. For example, the sensor 114 may be a temperature sensor for detecting the temperature of an environment where the specific electronic device 110 is in. In another example, the sensor 114 may be a pressure sensor for detecting the pressure of an environment where the specific electronic device 110 is in. It is noted that, the above sensor are only examples of the present application, and the present invention is not limited thereto. The controller 113 can control related operations of hardware and software in the specific electronic device 110. The controller 113 can determine whether to generate related data according to the data output by the sensor 114.

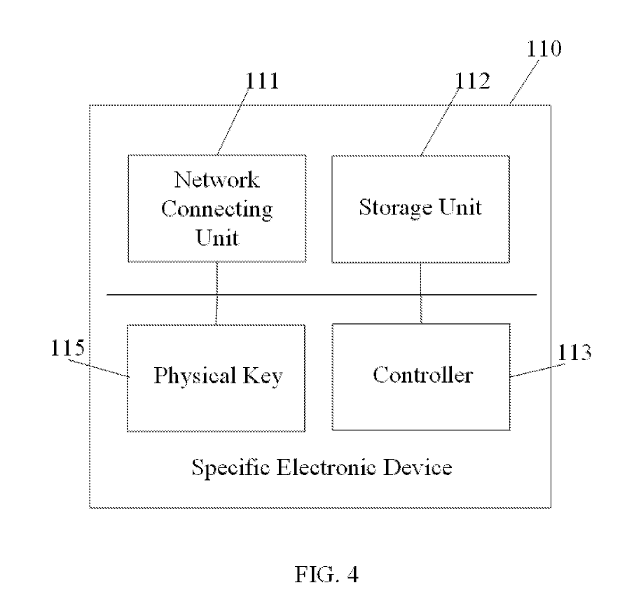

FIG. 4 is a schematic diagram illustrating another embodiment of a specific electronic device of the invention. As shown in FIG. 4, the specific electronic device 110 comprises a network connecting unit 111, a storage unit 112, at least one physical key 115, and a controller 113. The network connecting unit 111 can transmit data and/or connect to other electronic devices having network connecting capabilities via a network, such as a wired or wireless network such as Wi-Fi or Bluetooth network. Similarly, in some embodiments, the network connecting unit 111 may be a network connecting unit implemented with a low-power consumption technology, such as Bluetooth Smart technology. The network connecting unit 111 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected to other electronic devices. The storage unit 112 can store related data, such as identification data corresponding to the specific electronic device 110. The controller 113 can control related operations of hardware and software in the specific electronic device 110. The controller 113 can determine whether to generate related data according to whether the physical key 115 is pressed or not and/or the type of the pressed physical key 115.

As described, the intermediate electronic device 130 may be any electronic device having network connecting capabilities. The intermediate electronic device 130 may be a computer or a portable device, such as a mobile phone, a smart phone, a PDA (Personal Digital Assistant), a GPS (Global Positioning System), a notebook, or a tablet computer. In some embodiments, the intermediate electronic device 130 may have a network connecting unit implemented with a low-power consumption technology, such as Bluetooth Smart technology. The network connecting unit of the intermediate electronic device 130 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit of the intermediate electronic device 130 is in the central mode. In other words, the network connecting unit of the intermediate electronic device 130 has data receiving capabilities, and the network connecting unit of the intermediate electronic device 130 can actively connect to other electronic devices.

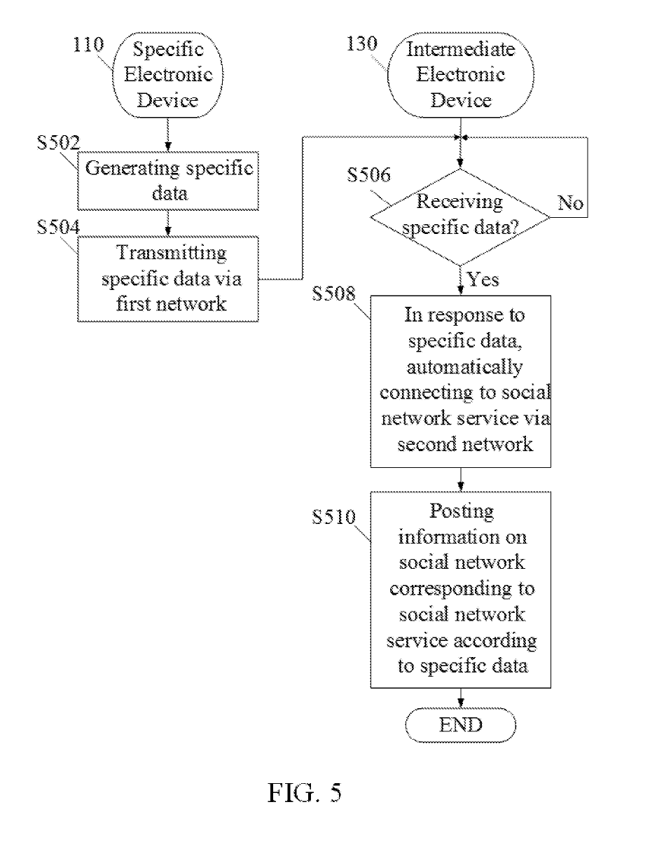

FIG. 5 is a flowchart of an embodiment of a method for connecting to a social network service of the invention.

In step S502, the specific electronic device 110 generates specific data, and in step S504, transmits the specific data via a first network 120, such as a wired or wireless network such as Wi-Fi or Bluetooth network by using the network connecting unit 111. It is noted that, the specific electronic device 110 can generate the specific data according to different applications and requirements, which will be discussed later. It is understood that, in some embodiments, the network connecting unit 111 may be a network connecting unit implemented with a low-power consumption technology, such as Bluetooth Smart technology. The Bluetooth Smart technology supports two modes, such as central and peripheral. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected by other electronic devices. In step S506, the intermediate electronic device 130 determines whether any specific data is received via a network. Similarly, in some embodiments, the network connecting unit of the intermediate electronic device 130 may be a network connecting unit implemented with a low-power consumption technology, such as Bluetooth Smart technology. The Bluetooth Smart technology supports two modes: central and peripheral. In some embodiments, the network connecting unit of the intermediate electronic device 130 is in the central mode. In other words, the network connecting unit of the intermediate electronic device 130 has data receiving capabilities, and the network connecting unit of the intermediate electronic device 130 can actively connect to other electronic devices. When no specific data is received (No in step S506), the procedure remains at step S506. When specific data is received (Yes in step S506), in step S508, in response to the received specific data, the intermediate electronic device 130 connects to a social network service 150 via a second network 140, and in step S510, posts information on a social network corresponding to the social network service 150 according to the specific data. It is understood that, in some embodiments, the information may comprise a score and/or an evaluation for at least one object, such as a dish, a restaurant, a hotel, a place, a service, a product, and/or a commercial entity. It is noted that, the above information is only an example of the present application, and the present invention is not limited thereto. Any information regarding to the object can be used in the present invention.

It is noted that, in some embodiments, the identification data corresponding to the specific electronic device 110 can be transmitted along with the specific data generated by the specific electronic device 110. The intermediate electronic device 130 will perform subsequent managements for the received identification data and the specific data.

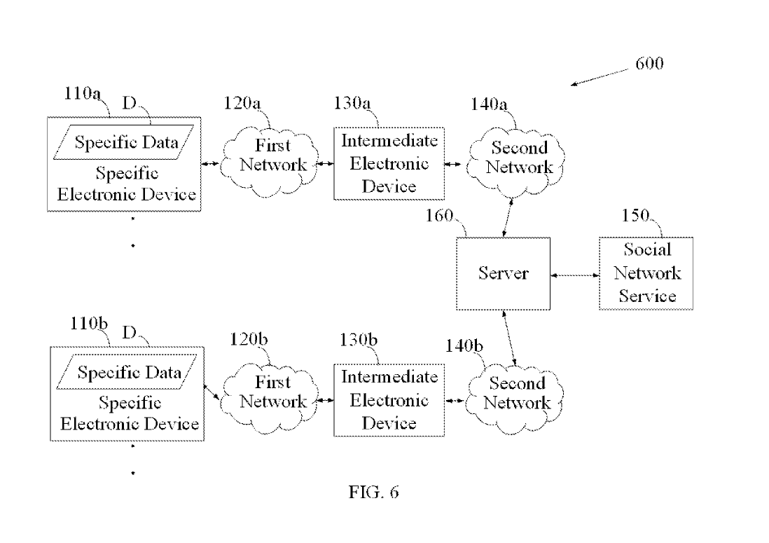

FIG. 6 is a schematic diagram illustrating another embodiment of a system for connecting to a social network service of the invention. The system for connecting to a social network service 600 comprises at least one specific electronic device 110a and an intermediate electronic device 130a. The specific electronic device 110a and the intermediate electronic device 130a may be any electronic device having network connecting capabilities. The specific electronic device 110a can generate specific data D, and transmits the specific data D via a first network 120a, such as a wired or a wireless network such as a Wi-Fi or a Bluetooth network. The intermediate electronic device 130a can receive the specific data D, which is transmitted from the different specific electronic devices 110a. The intermediate electronic device 130a can connect to a server 160 via a second network 140a, such as a wired or a wireless network. Additionally, the system for connecting to a social network service 600 further comprises at least one specific electronic device 110b and an intermediate electronic device 130b. The specific electronic device 110b and the intermediate electronic device 130b may be any electronic device having network connecting capabilities. The specific electronic device 110b can generate specific data D, and transmits the specific data D via a first network 120b, such as a wired or a wireless network such as a Wi-Fi or a Bluetooth network. The intermediate electronic device 130b can receive the specific data D, which is transmitted from the different specific electronic devices 110b. The intermediate electronic device 130b can connect to a server 160 via a second network 140b, such as a wired or a wireless network. The server 160 can perform managements for the specific data received from the different intermediate electronic devices 130a and 130b. The server 160 can connect to a social network service 150 via a third network (not shown in FIG. 6), such as a wired or a wireless network such as a Wi-Fi or a Bluetooth network. Similarly, in some embodiments, the social network service 150 may be a service provided by at least one specific server (not shown in FIG. 6). It is understood that, in some embodiments, the intermediate electronic devices 130a and 130b can be deployed in the same place, such as a restaurant. In some embodiments, the intermediate electronic devices 130a and 130b can be respectively deployed in the different places.

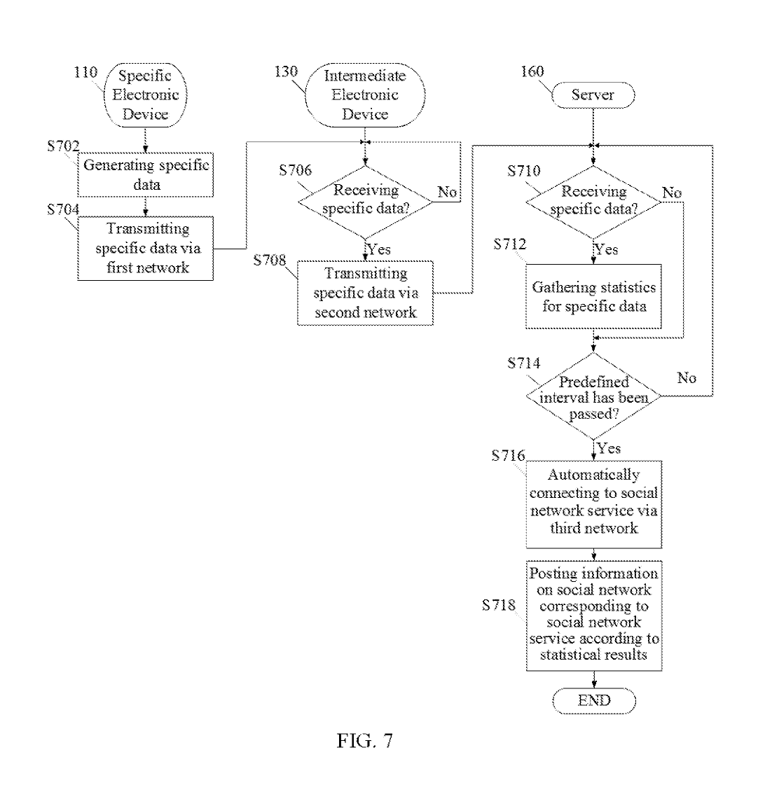

FIG. 7 is a flowchart of another embodiment of a method for connecting to a social network service of the invention. It is understood that, in the embodiments, the specific electronic device 110 may be the specific electronic device 110a or the specific electronic device 110b, and the intermediate electronic device 130 may be the intermediate electronic device 130a or the intermediate electronic device 130b.

In step S702, the specific electronic device 110 generates specific data, and in step S704, transmits the specific data via a first network, such as a wired or wireless network such as Wi-Fi or Bluetooth network by using a network connecting unit of the specific electronic device 110. It is noted that, the specific electronic device 110 can generate the specific data according to different applications and requirements, which will be discussed later. It is understood that, in some embodiments, the network connecting unit may be a network connecting unit implemented with a low-power consumption technology, such as Bluetooth Smart technology. The Bluetooth Smart technology supports two modes, such as central and peripheral. In some embodiments, the network connecting unit is in the peripheral mode. In other words, the network connecting unit has data broadcasting capabilities, and the network connecting unit cannot actively connect to other electronic devices, wherein the network connecting unit can be passively connected by other electronic devices. In step S706, the intermediate electronic device 130 determines whether any specific data is received via a network. Similarly, in some embodiments, the network connecting unit of the intermediate electronic device 130 may be a network connecting unit implemented with a low-power consumption technology, such as Bluetooth Smart technology. The Bluetooth Smart technology supports two modes: central and peripheral. In some embodiments, the network connecting unit of the intermediate electronic device 130 is in the central mode. In other words, the network connecting unit of the intermediate electronic device 130 has data receiving capabilities, and the network connecting unit of the intermediate electronic device 130 can actively connect to other electronic devices. When no specific data is received (No in step S706), the procedure remains at step S706. When specific data is received (Yes in step S706), in step S708, the intermediate electronic device 130 transmits the received specific data via a second network, such as a wired or wireless network such as Wi-Fi or Bluetooth network. On the other hand, in step S710, the server 160 determines whether the specific data corresponding to different intermediate electronic devices 130 is received or not. When no specific data is received (No in step S710), the procedure goes to step S714. When the specific data corresponding to different intermediate electronic devices 130 is received (Yes in step S710), in step S712, the server 160 gathers statistics for the received specific data. Then, in step S714, it is determined whether a predefined interval, such as a day has been passed. When the predefined interval has not been passed yet (No in step S714), the procedure returns to step S710. When the predefined interval has been passed (Yes in step S714), in step S716, the server 160 connects to a social network service 150 via a third network, and in step S718, posts information on a social network corresponding to the social network service 150 according to a statistical results corresponding to the statistics. Similarly, in some embodiments, the information may comprise a score and/or an evaluation for at least one object, such as a dish, a restaurant, a hotel, a place, a service, a product, and/or a commercial entity. It is noted that, the above information is only an example of the present application, and the present invention is not limited thereto. Any information regarding to the object can be used in the present invention.

Similarly, in some embodiments, the identification data corresponding to the specific electronic device 110 can be transmitted along with the specific data generated by the specific electronic device 110. The server 160 will perform subsequent managements for the received identification data and the specific data.

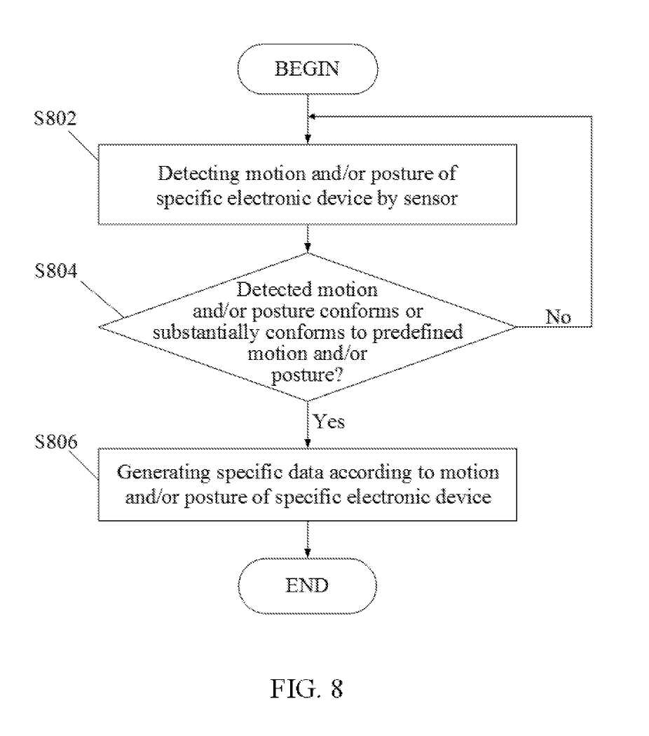

FIG. 8 is a flowchart of an embodiment of a method for generating specific data of the invention. In step S802, at least one sensor detects a motion and/or posture corresponding to the specific electronic device 110. It is understood that, in some embodiments, the sensor may be an accelerometer for generating information of velocity and displacement when the device moves. In some embodiments, the sensor may be a Gyro sensor for generating information of angular acceleration when the device moves. In some embodiments, the motion sensor may be an e-compass for detecting an angle of the device in regard to a geographical direction, such as the direction of the North Pole or the South Pole. It is noted that, the above sensors are only examples of the present application, and the present invention is not limited thereto. Any sensor that can detect the posture and/or motion of an electronic device can be applied in the present invention. As described, the sensor can detect the posture of the specific electronic device. It is understood that, in some embodiments, the posture can be the angular information of the specific electronic device in regard to at least one reference point. In some embodiments, the posture of the specific electronic device can be represented by an angle corresponding to an axis which is vertical to at least one plane of the specific electronic device in regard to a specific direction, such as the gravity direction or the geographical direction. In step S804, it is determined whether the motion and/or posture of the specific electronic device 110 conforms or substantially conforms to at least one predefined motion and/or posture. When the motion and/or posture of the specific electronic device 110 does not conform or substantially conform to the predefined motion and/or posture (No in step S804), the procedure returns to step S802. When the motion and/or posture of the specific electronic device 110 conforms or substantially conforms to the predefined motion and/or posture (Yes in step S804), in step S806, specific data is generated according to the motion and/or posture of the specific electronic device 110. It is understood that, in some embodiments, the specific electronic device 110 can generate different specific data according to different motions and/or posture, and the intermediate electronic device 130 or the server 160 can post different information on the social network corresponding to the social network service 150 according to the different specific data.

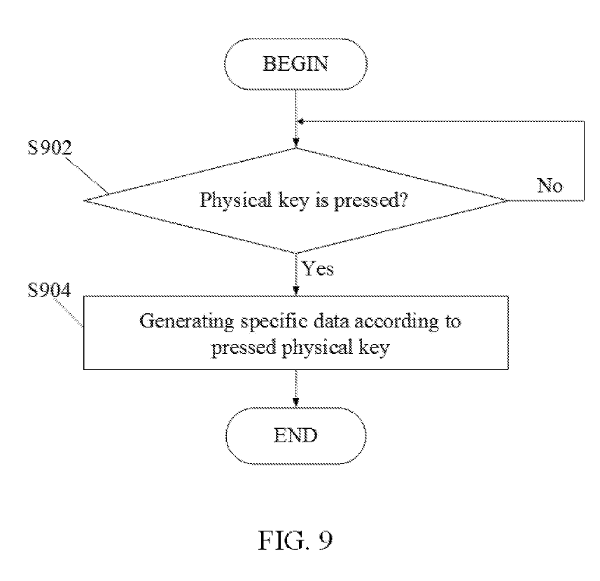

FIG. 9 is a flowchart of another embodiment of a method for generating specific data of the invention. In step S902, it is determined whether at least one physical key of the specific electronic device 110 is pressed or not. When the physical key is not pressed (No in step S902), the procedure remains at step S902. When the physical key is pressed (Yes in step S902), in step S904, specific data is generated according to the pressed physical key. Similarly, the specific electronic device 110 can generate different specific data according to different physical keys which have been pressed, and the intermediate electronic device 130 or the server 160 can post different information on the social network corresponding to the social network service 150 according to the different specific data.

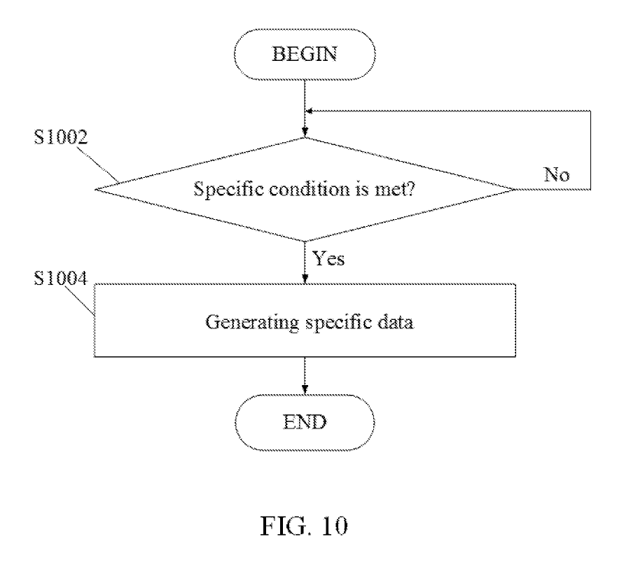

FIG. 10 is a flowchart of another embodiment of a method for generating specific data of the invention. In step S1002, the specific electronic device 110 determines whether a specific condition is met or not. It is noted that, the specific condition may be different according to different requirements and applications. For example, the specific condition may be a specific time. When the current time reaches the specific time, the specific condition is met. In another example, the specific condition may be a specific region. When the location of the specific electronic device 110 is within the specific region, the specific condition is met. In another example, a sensor of the specific electronic device 110 can detect related data, such as an environmental factor, and it is determined whether the detected data conforms to a specific threshold value or a specific state. When the detected data conforms to the specific threshold value or the specific state, the specific condition is met. For example, the sensor may be a temperature sensor for detecting the temperature of an environment where the specific electronic device 110 is in. In another example, the sensor may be a pressure sensor for detecting the pressure of an environment where the specific electronic device 110 is in. It is noted that, the above sensors are only examples of the present application, and the present invention is not limited thereto. When the specific condition is not met (No in step S1002), the procedure remains at step S1002. When the specific condition is met (Yes in step S1002), in step S1004, specific data is generated. Similarly, the specific electronic device 110 can generate different specific data according to different specific conditions, and the intermediate electronic device 130 or the server 160 can post different information on the social network corresponding to the social network service 150 according to the different specific data.

It is understood that, in some embodiments, the specific electronic device 110 can optionally enter a sleep mode after a specific period subsequent to the transmission of the specific data. In some embodiments, the specific electronic device 110 can continuously transmit the generated specific data in a predefined period via a wireless network, stop transmitting the specific data after the predefined period, and optionally enter a sleep mode. In some embodiments, the specific electronic device 110 can continuously transmit the generated specific data via a wireless network. After the intermediate electronic device 130 receives the specific data transmitted by the specific electronic device 110, the intermediate electronic device 130 can connect to the specific electronic device 110, and instruct the specific electronic device 110 to stop generating and transmitting the specific data.

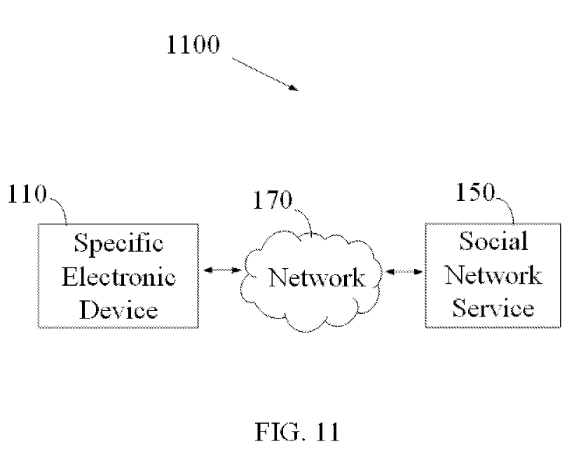

FIG. 11 is a schematic diagram illustrating another embodiment of a system for connecting to a social network service of the invention. The system for connecting to a social network service 1100 comprises at least one specific electronic device 110. The specific electronic device 110 can connect to a social network service 150 via a network 170, such as a wired or wireless network such as Wi-Fi or Bluetooth network. Similarly, in some embodiments, the social network service 150 may be a service provided by at least one specific server (not shown in FIG. 11).

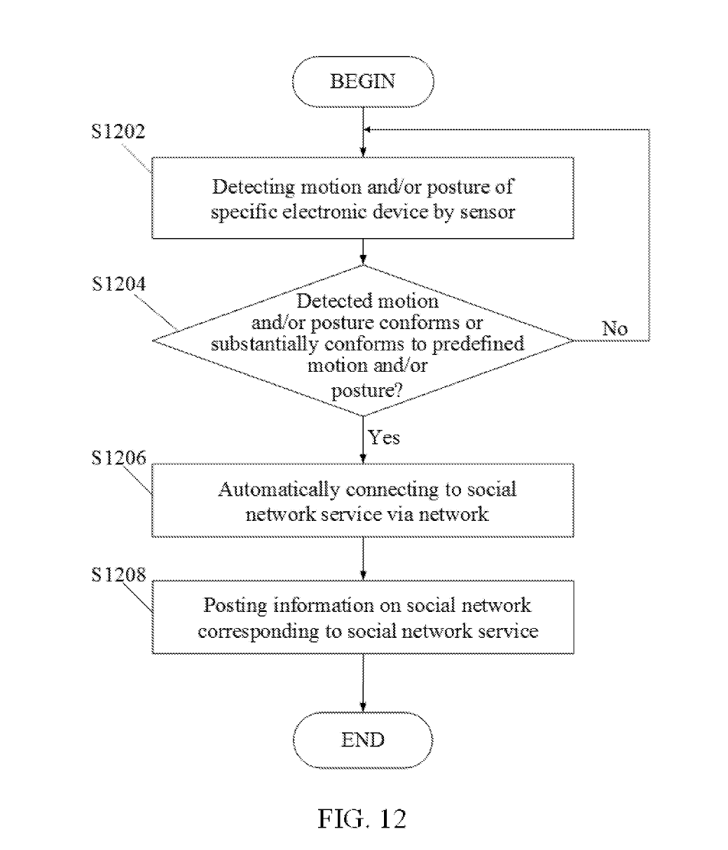

FIG. 12 is a flowchart of another embodiment of a method for connecting to a social network service of the invention.

In step S1202, at least one sensor detects a motion and/or posture corresponding to the specific electronic device 110. It is understood that, in some embodiments, the sensor may be an accelerometer for generating information of velocity and displacement when the device moves. In some embodiments, the sensor may be a Gyro sensor for generating information of angular acceleration when the device moves. In some embodiments, the motion sensor may be an e-compass for detecting an angle of the device in regard to a geographical direction, such as the direction of the North Pole or the South Pole. It is noted that, the above sensors are only examples of the present application, and the present invention is not limited thereto. Any sensor that can detect the posture and/or motion of an electronic device can be applied in the present invention. As described, the sensor can detect the posture of the specific electronic device. It is understood that, in some embodiments, the posture can be the angular information of the specific electronic device in regard to at least one reference point. In some embodiments, the posture of the specific electronic device can be represented by an angle corresponding to an axis which is vertical to at least one plane of the specific electronic device in regard to a specific direction, such as the gravity direction or the geographical direction. In step S1204, it is determined whether the motion and/or posture of the specific electronic device 110 conforms or substantially conforms to at least one predefined motion and/or posture. When the motion and/or posture of the specific electronic device 110 does not conform or substantially conform to the predefined motion and/or posture (No in step S1204), the procedure returns to step S1202. When the motion and/or posture of the specific electronic device 110 conforms or substantially conforms to the predefined motion and/or posture (Yes in step S1204), in step S1206, the specific electronic device 110 automatically connects to a social network service 150 via a network 170, and in step S1208, posts information on a social network corresponding to the social network service 150. Similarly, in some embodiments, the information may comprise a score and/or an evaluation for at least one object, such as a dish, a restaurant, a hotel, a place, a service, a product, and/or a commercial entity. It is noted that, the above information is only an example of the present application, and the present invention is not limited thereto. Any information regarding to the object can be used in the present invention.

For example, a restaurant may have several partitions, wherein an intermediate electronic device can be deployed in each of the partitions, and a specific electronic device can be set on each table of the respective partitions. It is noted that, each intermediate electronic device can receive the specific data generated by the respective specific electronic devices in the corresponding partition. When a customer thinks that the service provided by the restaurant is good, the customer can press a physical key of the specific electronic device or shake the specific electronic device, thus driving the specific electronic device to generate and broadcast specific data via a wireless network, such as a Bluetooth network. It is noted that, the specific data may represent the service evaluation for the restaurant. At the time, the intermediate electronic device, such as a smart phone or a tablet computer can receive the specific data broadcasted by the specific electronic device via a wireless network, and transmit the specific data and/or the identification data corresponding to the specific electronic device to a server. It is noted that, any intermediate electronic device in the respective partitions will transmit the specific data and/or the identification data corresponding to the specific electronic device to the server once the specific data is received. The server gathers statistics for the specific data received from different intermediate electronic devices of the restaurant, and periodically connects to a social network service, thus to post the daily statistical results on the corresponding social network. It is understood that, in some cases, the respective intermediate electronic device can gather statistics for the received specific data, and periodically connects to a social network service, thus to post the daily statistical results on the corresponding social network. It is noted that, the example in a restaurant is only an example of the present application, and the present invention is not limited thereto. The specific electronic device can be deployed in any place, such as a restaurant, hospital, school, store, sports course, factory, or house.

Therefore, the methods and system for connecting to a social network service of the present invention can automatically connect to a social network service according to the data received from another electronic device, or the motion and/or posture generated by the electronic device itself, thereby reducing the conventional inconvenience and improving the efficiency when performing related operations, and accomplishing the objective of information management.

Methods for connecting to a social network service, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for connecting to a social network service, comprising:
generating specific data by at least one specific electronic device;
transmitting the specific data via a first network by the at least one specific electronic device;
receiving the specific data by an intermediate electronic device from the at least one specific electronic device via the first network; and
in response to the specific data, connecting to a social network service via a second network by the intermediate electronic device.

2. The method of claim 1, further comprising:
transmitting the specific data to a server via the second network by the intermediate electronic device; and
in response to the specific data, connecting to the social network service via a third network by the server.

3. The method of claim 2, further comprising:
gathering statistics for the specific data received from different intermediate electronic devices by the server; and
posting information on a social network corresponding to the social network service according to a statistical results corresponding to the statistics by the server.

4. The method of claim 1, further comprising posting information on a social network corresponding to the social network service according to the specific data by the intermediate electronic device.

5. The method of claim 1, wherein the specific electronic device comprises at least one sensor for detecting a motion or posture corresponding to the specific electronic device, and the specific electronic device generates the specific data according to the motion or posture corresponding to the specific electronic device.

6. The method of claim 1, wherein the specific electronic device comprises at least one physical key, and the specific electronic device generates the specific data when the physical key is pressed.

7. The method of claim 1, wherein the specific electronic device determines whether a specific condition is met or not, and the specific electronic device generates the specific data when the specific condition is met.

8. A method for connecting to a social network service for use in an electronic device, comprising:
detecting a motion or posture corresponding to the electronic device by at least one sensor of the electronic device;
automatically connects to a social network service by the electronic device when the motion or posture corresponding to the electronic device conforms or substantially conforms to a predefined motion or a predefined posture.

9. A system for connecting to a social network service, comprising:
at least one specific electronic device generating specific data, and transmitting the specific data via a first network; and
an intermediate electronic device receiving the specific data from the at least one specific electronic device via the first network, and in response to the specific data, connecting to a social network service via a second network.

10. A system for connecting to a social network service for use in an electronic device, comprising:
a network connecting unit;
at least one sensor detecting a motion or posture corresponding to the electronic device; and
a controller determining whether the motion or posture corresponding to the electronic device conforms or substantially conforms to a predefined motion or a predefined posture, and automatically connects to a social corresponding to the electronic device conforms or substantially conforms to a predefined motion or a predefined posture.
